(19) United States
(12) Patent Application Publication
(10) Pub. No.: US 2024/0296616 A1
(43) Pub. Date: Sep. 5, 2024

(54) DYNAMIC VIRTUAL REALITY CONTENT ADAPTATION TO OPTIMIZE ACTIVITIES

(71) Applicant: INTERNATIONAL BUSINESS MACHINES CORPORATION, Armonk, NY (US)

(72) Inventors: Saraswathi Sailaja Perumalla, Visakhapatnam (IN); Sarbajit K. Rakshit, Kolkata (IN); Ravi Sankar Parvathina, Visakhapatnam (IN)

(21) Appl. No.: 18/177,795

(22) Filed: Mar. 3, 2023

(51) Int. Cl. G06T 15/00; G06T 19/00

(52) U.S. Cl. CPC G06T 15/005; G06T 19/003; G06T 2215/16

(57) ABSTRACT

Techniques are described with respect to a system, method, and computer product for optimizing activities. An associated method includes optimizing activities includes receiving at least one workflow associated with a facility; rendering a virtual environment of the facility based on the workflow; analyzing a plurality of activities of a user associated with the workflow; and optimizing the workflow within the virtual environment based on the analysis.

### FIELD

This disclosure relates generally to computing systems and augmented reality, and more particularly to computing systems, computer-implemented methods, and computer program products configured to utilize cognitive computing techniques to analyze facility data and dynamically adapt virtual reality content in order to optimize activities.

### BACKGROUND

Workflows for a facility, such as an industrial floor, typically require numerous activities to be performed by individuals within the facility such as, but not limited to, operators traversing the industrial floor in order to operate facility equipment/machinery. For example, issues such as unnecessary traversing of large industrial floors, facility-specific bottlenecks, inefficiencies, and other shortcomings can result in misallocation of facility resources, improper delegation of tasks, and other applicable outcomes that significantly reduce workflow productivity of a facility.

Augmented reality (AR) is an interactive experience combining virtual elements, with a real-world environment where the objects that reside in the real world are enhanced by computer-generated perceptual information, sometimes across multiple sensory modalities, including visual, auditory, haptic, somatosensory, and olfactory. AR can be defined as a system that fulfills a combination of real and virtual worlds, real-time interaction, and accurate 3D registration of virtual and real objects. In particular, AR can be used to visualize tasks of individuals in real-time, and seamlessly interweave the physical world such that it is perceived as an immersive aspect of the real environment (i.e., the facility and its resources).

In addition, due to the fact that facilities such as industrial systems include multiple different resources (e.g., devices, equipment/machinery, personnel, etc.) operating in coordination, it can be both difficult and inefficient for an operator to traverse a large industrial floor in order to interface/interact with various facility resources. With the assistance of advanced AR technologies, the information about the surrounding real world of the operator becomes interactive, and information about the facility, its objects, and activities performed within the facility is overlaid on the real world.

### SUMMARY

Additional aspects and/or advantages will be set forth in part in the description which follows and, in part, will be apparent from the description, or may be learned by practice of the invention.

Embodiments relate to a method, system, and computer program product for optimizing activities. In some embodiments, the computer-implemented method for optimizing activities includes receiving at least one workflow associated with a facility; rendering a virtual environment of the facility based on the workflow; analyzing a plurality of activities of a user associated with the workflow; and optimizing the workflow within the virtual environment based on the analysis.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of an augmented reality-based activity optimization system environment, according to an exemplary embodiment;

FIG. 3 illustrates a facility module and an optimization module associated with the system of FIG. 1, according to an exemplary embodiment;

FIG. 4 illustrates a schematic diagram showing a virtual environment depicting an industrial floor of a facility associated with the system of FIG. 1, as viewed through a computer-mediated reality device, according to an exemplary embodiment;

FIG. 5 illustrates the virtual environment of the facility of FIG. 4 including visual indicators designed to optimize activities of workflows associated with the system of FIG. 1, according to an exemplary embodiment;

FIG. 6 illustrates a flowchart depicting a method for optimizing activities, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for optimizing activities associated with workflows of a facility. Operators and other applicable employees within facility environments (e.g., industrial locations, factories, warehouses, etc.) interact with equipment, machinery, and applicable physical entities (e.g., products, systems, services, personnel, and/or the like) as part of workflows specific to the facility. Typically, these operators navigate the facility environments in order to perform activities that are a requirement of the applicable workflow; however, traversing the environment may be inefficient depending on factors such as the size, layout, complexity, equipment/machinery availability, etc. of the facility environment, which may have direct impact on overall productivity. For example, while performing navigation of the environment to control the machines of the industrial floor, the operator may not be willing to perform unnecessary movement if the environment is exactly mapped with the industrial floor, which may result in improper and/or redundant performance of the activities.

Augmented Reality (AR) allows the collection of data associated with the facility environment and individuals within in order to depict sensory information seamlessly interwoven with the physical world such that it is perceived as an immersive aspect of the real environment. The present invention allows for data collected by sensor networks, IOT devices, wearable computing devices, etc. to detect and analyze activities of workflows associated with the facility and its resources within (e.g., equipment, machinery, operators, personnel, services/software, etc.), and determine whether the activities are a value added activity or a non-value added activity based on the analyses. Based on this determination, the present invention further utilizes AR technologies to not only visualize the facility environment by mapping activities to the industrial floor and its resources, but also taking the next step of optimizing workflows by dynamically adapting the activities within an augmented reality environment resulting in more efficient activities associated with the workflows. Thus, the present embodiments have the capacity to not only to improve ergonomics, but also facilitate how resources of the facility environment are to be arranged in a digitally visualized environment in order to optimize activities associated with workflows of the facility along with facility design (e.g., feasibility and placement of facility resources).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described herein, virtual reality (“VR”) refers to a computing environment configured to support computer-generated objects and computer mediated reality incorporating visual, auditory, and other forms of sensory feedback. It should be noted that a VR environment may be provided by any applicable computing device(s) configured to support a VR, augmented reality, and/or mixed reality user interacting with their surroundings, said interactions including but not limited to user movement/gazing, manipulation of virtual and non-virtual objects, or any other applicable interactions between users and computing devices known to those of ordinary skill in the art.

As described herein, augmented reality is technology that enables enhancement of user perception of a real-world environment through superimposition of a digital overlay in a display interface providing a view of such environment. Augmented reality enables display of digital elements to highlight or otherwise annotate specific features of the physical world based upon data collection and analysis. For instance, augmented reality can provide respective visualizations of various layers of information relevant to displayed real-world scenes.

As described herein, a “facility” is an industrial setting including, but not limited to an industrial floor, an assembly line, a hospital, a manufacturing plant, a packaging plant, a mining operation, an oil drilling operation, a shipping operation, a package delivery operation, a pathological laboratory, or any other such industrial and/or automated setting. As described herein, a “workflow” is a collection of one or more activities associated with the facility performed by personnel, processes, products, equipment/machinery, and/or operations/services associated with the facility. While the present disclosure uses a facility environment such as an industrial floor as an example environment to describe the technical solutions described herein, it is understood that the technical solutions can be used in other settings such as hospitals, laboratories, transportation lines, airports, and any other environment in which resources from which workflows are used.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

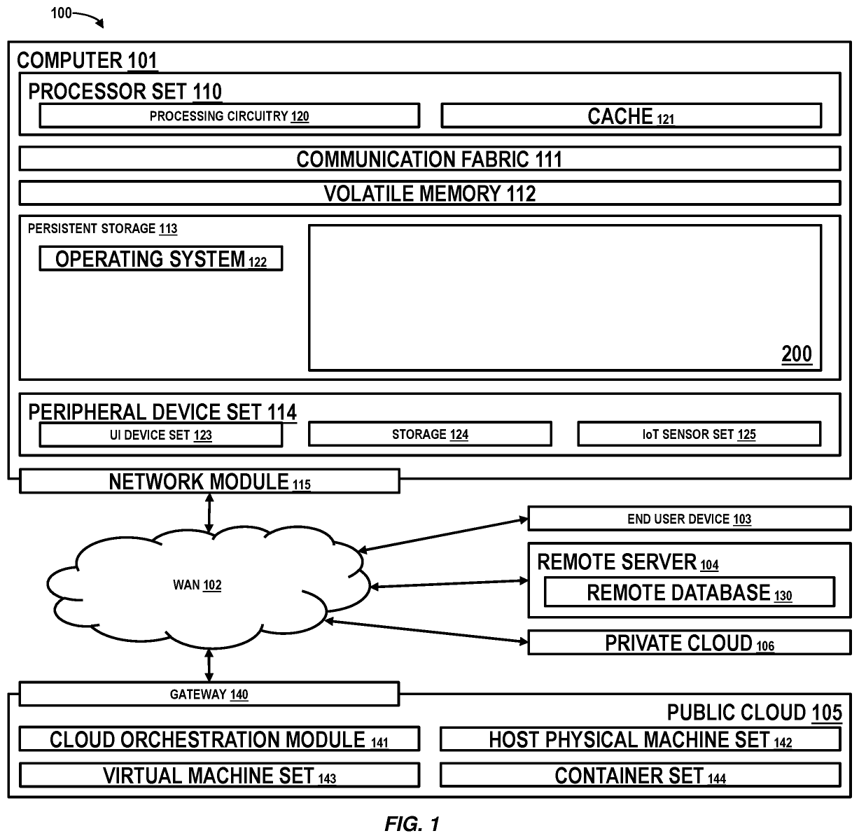

The following described exemplary embodiments provide a system, method and computer program product for optimizing activities associated with workflows of a facility. Referring now to FIG. 1, a computing environment 100 contains an example of an environment for the execution of at least some of the computer code involved in performing the inventive methods, such as block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

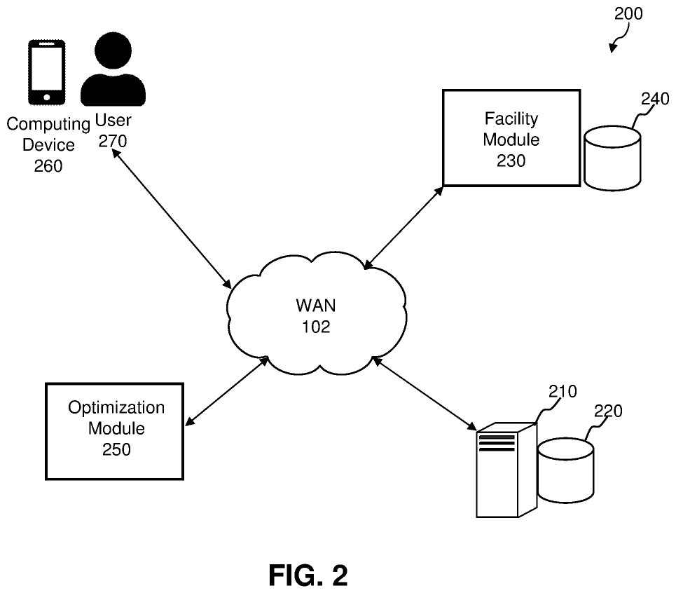

Referring now to FIG. 2, a functional block diagram of a networked computer environment illustrating an augmented reality-based activity optimization system 200 (hereinafter “system”) comprising a server 210 communicatively coupled to a database 220, a facility module 230 comprising a facility module database 240, an optimization module 250, and a computing device 260 associated with a user 270, each of which are communicatively coupled over WAN 102 (hereinafter “network”) and data from the components of system 200 transmitted across the network is stored in database 220.

In some embodiments, server 210 is configured to operate a centralized platform configured for user 270 to access via computing device 260 and/or and other applicable computing devices. In a preferred embodiment, the centralized platform is a workflow optimization program associated with a facility in which the workflow optimization program aims to optimize workflows of the facility based on analyses of components of the facility (e.g., equipment, machinery, operators, personnel, services/software, etc.) and/or activities of the workflows. In some embodiments, user interfaces of the workflow optimization program are provided by optimization module 250 and an augmented reality environment of the facility is provided by facility module 230 for display on computing device 260, both of which are made available to user 270 via the centralized platform in which the centralized platform is designed to run on computing device 260 allowing user 270 to send data, input data, collect/receive data, etc. It should be noted that optimization of activities may include but is not limited to prioritizing, minimizing, and/or predicting industrial floor workflow time reduction/overall activity elimination, mitigation, preventative measures, and/or maintenance.

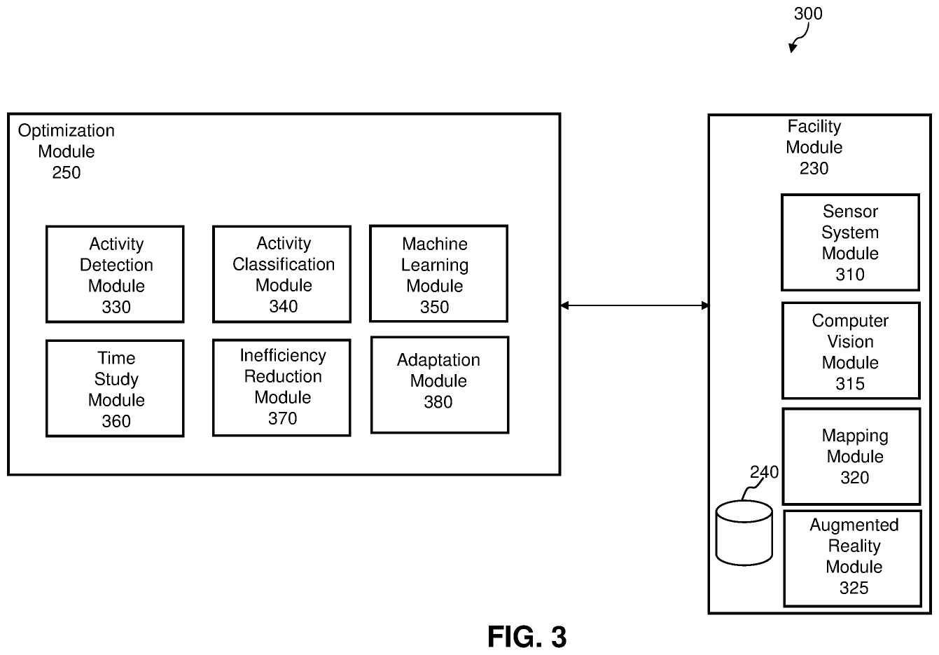

In some embodiments, server 210 is configured to utilize one or more web crawlers and receive crowd-sourcing based data in order to gather and/or update data associated with the environment and resources of the facility and stored the data in a facility profile configured to be housed in database 220. Database is configured to be accessed by facility module 230 allowing facility module 230 to continuously perform mapping of the facility environment and its resources based on data derived from analyses performed on sensor data collected from one or more sensor systems of system 200 as described in greater detail in reference to FIG. 3. In some embodiments, mapping of the facility environment and its resources comprises generating digital simulations of the resources designed to serve as virtual/digital representations of facility resources that are not only depicted within the generated augmented reality environment, but also enables monitoring, testing, modeling, analysis, and simulation of the resources via data collected from the resources. For example, an avatar depicted within the generated augmented reality environment may be a representation of the applicable facility personnel in which data collected from a wearable device worn by the applicable facility personnel (e.g., movements/patterns, biological data, gaze direction, etc.) is analyzed by one or more of facility module 230 and optimization module 250 and reflected with the avatar within the augmented reality environment. The mappings of the augmented reality environment and plurality of activities associated with workflows of the facility are configured to be stored in facility module database 240. In addition, facility module database 240 comprises one or more repositories of data collected, processed, and/or presented within the AR environment including but not limited to motion data (e.g., motion patterns) associated with facility personnel collected from applicable wearable device, AR environment-based analytics, and any other applicable data associated with virtual reality, augmented reality, and/or mixed systems known to those of ordinary skill in the art. Facility module 230 is further configured to host one or more application programing interfaces (API) which may be utilized by the centralized platform.

Computing device 260 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network or querying a database.

Referring now to FIG. 3, an example architecture 300 of facility module 230 and optimization module 250 is depicted, according to an exemplary embodiment. In some embodiment, facility module 230 comprises a sensor system module 310, a computer vision module 315, a mapping module 320, and an augmented reality module 325. Optimization module 250 comprises an activity detection module 330, an activity classification module 340, a machine learning module 350, a time study module 360, an inefficiency reduction module 370, and an adaptation module 380. It should be noted that facility module 230 and optimization module 250 are communicatively coupled over the network allowing for outputs and/or analyses performed by each respective module to be utilized in applicable training datasets to be utilized by applicable machine learning models operated by machine learning module 350 and/or applicable cognitive systems associated with system 200.

Sensor system module 310 is a collection of one or more sensor systems associated with the facility and its resources in which sensors of the sensor systems may include, but are not limited to cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, IoT sensors, or any other applicable type of sensors known to those of ordinary skill in the art.

The sensors may be installed in various locations of the facility, including but not limited to clothing of facility personnel, within the equipment/machinery traversing the industrial floor, within applicable computing devices (e.g., IOT devices, wearable devices, etc.), on walls or other fixed surfaces of the areas within the facility, etc. In addition to or in lieu of the data provided by sensors, user 270 may enter data about equipment/machinery availability, equipment/machinery functions mapping to facility personnel, etc. on the centralized platform. It should be noted that one of the purposes of sensor system module 310 is to collect real-time and/or intermittent data from the environment of the facility, its resources, and any applicable third parties (e.g., social media data, weather data, ergonomics data, etc.). In some embodiments, sensor system module 310 is communicatively coupled to one or more wearable devices worn by facility personnel (e.g., operators, etc.) in order to collect operator sensor data for the purpose of performing analytics associated with the workflow activities for optimization purposes. For example, sensor data derived from wearable devices, such as biological data (e.g., heartrate, facial expressions, pause in movement, etc.), allow optimization module 250 to ascertain the level of difficulty associated with one or more activities of the workflow for the facility personnel.

Computer vision module 315 is configured to utilize algorithms or techniques that identify and process objects in images and videos derived from sensor data collected by sensor system module 310. In particular, computer vision module 315 receives computer vision data including images and videos from one or more of server 210, sensor system module 310, or any other applicable sources for images and videos associated with the facility (e.g. monitoring system, security system, etc.). Computer vision trains computers to interpret and understand the received data such as digital image and/or video content, and can include techniques such as machine learning and/or use of machine learning models such as deep learning models (provided by machine learning module 350) to accurately identify and/or classify objects and resources of the facility, and possibly react to what it identifies (e.g., managing time scheduling for applicable machinery/equipment, recommendations to operators for intervention, etc.). In some embodiment, one or more computer vision algorithms can break or decompose the original region (images of) into smaller parts, classifying the smaller parts with simpler concepts. One or more computer vision algorithms can also retrieve or receive similar images associated with the facility. In an embodiment, one or more knowledge augmented machine learning algorithms generated by machine learning module 350 can automatically annotate regions. Acquired knowledge about concepts can be used to search for candidate regions to be annotated. For example, based on one or more sensors of sensory system module 310, candidate regions may be determined by computer vision module 315 based on a higher frequency of an operator of the facility interacting with a specific equipment/machinery compared to historically (historical data analyzed by machine learning module 350) indicating that an issue exists with the specific equipment/machinery allowing optimization module 250 to identify and analyze activities of the workflow in order to generate issue rectifying and/or mitigating instructions to optimize the workflow of the activities.

Mapping module 320 is tasked with mapping sensor data and outputs of analyses of sensor data to resources in the facility. Mapping functions performed by mapping module 320 may be based on one or more of data provided by server 210 (e.g., contextual data, knowledge graphs, etc.), previously rendered maps of the facility, outputs of one or more machine learning models operated by machine learning module 350, inputs of user 270 on the centralized platform, applicable data provided by relevant third parties (e.g., updates/instructions/specifications from original equipment manufacturer, etc.), etc. For example, activities of a workflow may be mapped to the specific equipment/machinery within the facility in which data, such as operator scheduling, operator access privileges (hereinafter referred to as “user operation privileges”), the movements of an operator and/or applicable facility personnel derived from sensor system module 310, and other identifiable indicators associated with the activities, is also mapped by mapping module 320. Mappings and derivatives of mappings are designed to be stored in facility module database 240. In some embodiments, mapping module 320 may transmit the aforementioned data in order for visual renderings of the mappings to be visualized by augmented reality module 325. For example, activities of the workflow may be visualized, in which the activities may be series of steps to be performed by one or more facility resources to carry out the workflow based on the mapping performed by mapping module 320. For example, a workflow may include processes and procedures for equipment to unload cargo out of a location in which different components of the cargo are to be transported to different locations within the facility. Mapping module 320 maps out the operator that is required to interact with the relevant equipment, the scheduling (e.g., availability, etc.) of the relevant equipment, the order that the components are to be moved, applicable biological data of the facility personnel associated with the particular workflow, and virtual steps for the facility operator to perform in order for the components to be removed from the location to reach their respective destinations.

Augmented reality module 325 is tasked with generating an AR-based visualization of the facility (e.g., a virtual reality model of the facility or superimposing virtual content over a real-world view of the facility in augmented reality) based on data provided by server 210, sensor system module 310, and/or computer vision module 315 along with visualizations of the aforementioned mappings performed by mapping module 320. Visualizations generated by augmented reality module 325 are designed to be depicted to user 270 (preferably donning computing device 260, a computer-mediated reality device) operating on the centralized platform. For example, computing device 260 may be an augmented reality device configured to superimpose visual content (e.g., representations of the facility, resources of the facility, workflows, derivatives thereof) over views of the facility. In some embodiments, augmented reality module 325 renders visual indications of available resources of the facility, scheduling and permissions associated with equipment/machinery, and activities of the workflows (e.g., workflows with mappings of associated activities to provide guides for operators and applicable facility personnel). The AR visualization of the virtual environment of the facility (hereinafter referred to as “virtual facility”) supports navigation of the virtual facility, viewing and interactions with resources between user 270 and the centralized platform, and viewing/implementation of optimizations of activities of workflows based on analyses of optimization module 250. The navigation, viewing, and interactions of the virtual facility by user 270 are supported by view toggling, zoom in/out features, content interaction, and/or any other VR/AR based features known to those of ordinary skill in the art. In some embodiments, user 270 may manually map workflows and activities thereof to facility resources allowing roles of facility personnel, purposes of equipment/machinery within the workflow, health of equipment/machinery, etc. to be accounted for in real-time and to be updated within the depiction of the virtual facility accordingly.

Activity detection module 330 is tasked with utilizing cognitive techniques (supported by machine learning module 350) to determine activities of workflows based on stored records provided by server 210 and/or sensor data provided by sensor system module 310 (along with wearable devices, IOT devices, etc. if applicable). For example, sensor data and biological data of facility personnel with the facility allows activity detection module 330 to detect that the facility personnel are performing one or more activities associated with a workflow and/or resource(s) of the facility. In addition, activity detection module 330 is configured to identify patterns, contexts, etc. associated with the one or more activities along with analyze various sensor data associated with facility personnel in order to enhance detection of activities of workflows. For example, an utterance of an operator such as, “This equipment requires a software update” is configured to be received by the applicable computing device, analyzed (e.g., parsed, tokenized, etc.), and utilized by activity detection module 330 in order to establish that an activity of a workflow associated with the equipment is being performed.

Activity classification module 340 is tasked with classifying the activities of workflows that are being attempted or performed based on detection of activities performed by activity detection module 330. In some embodiments, activity classification module 340, with the support of machine learning module 350, is configured to classify workflows and derivatives thereof based on supervised machine learning. For example, activity classification module 340 can distinguish between resources of the facility (e.g., a visitor as opposed to an operator) and classify the activity based on the detected distinctions, such as walking pattern within the industrial floor, facility personnel wearing a uniform and/or lack thereof, etc. In addition, activity classification module 340 is further configured to identify activities of specific roles of facility personnel (e.g., duties of the operator) based on the activity and/or workflow identified by activity detection module 330. In some embodiments, activity classification module 340 performs scoring of an activity based on various factors, such as but not limited to time required to perform the activity, amount of hazards/issues associated with the activity, scheduling/availability of the relevant equipment/machinery, difficulty of operating applicable equipment/machinery associated with the activity, location of the activity, impacting variables for the activity (e.g., current weather, population density of industrial floor, etc.), amount of physical labor associated with the activity, feasibility of implementing mitigation/rectification of inefficiencies of the activities, etc. The scoring of the activity may also be used as a metric in order for inefficiency reduction module 370 to determine which elements of the activity need to be amended, mitigated, or eliminated in order for the activity to be optimized. Activity classification module 340 is further configured to determine if an activity is a value added activity or a non-value added activity based on the aforementioned scoring in which an activity is classified as a non-value added activity based on the respective scores exceeding an activity threshold. For example, a design or configuration of the industrial floor may be determined as obsolete by inefficiency reduction module 370 in which inefficiency reduction module 370 may support user 270 inserting virtual replacement resources in the virtual facility that replicate the functions of actual pending replacement resources in order to determine if integration of the replacement resources optimize the applicable activities and/or workflow. The activity threshold may be established by one or more of server 210, user 270, and/or outputs of machine learning module 350.

Machine learning module 350 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. In particular, machine learning module 350 is configured to operate and maintain one or more machine learning models configured to utilized training datasets derived from server 210 and/or facility module 230 to ultimately generated outputs of the machine learning models representing optimizations of the activities of workflows, in which the optimizations are visualized within the virtual facility by augmented reality module 325. For example, the one or more machine learning algorithms may output predictions pertaining to the impact to the applicable workflow and/or activities based on the insertion of the virtual replacement resources into the virtual facility.

Time study module 360 is tasked with conducting time studies on activities of workflows for the purpose of optimizing the activities. In some embodiments, the time studies of workflows and derivatives thereof performed by time study module 360 are conducted according to baseline metrics established by one or more of user inputs of user 270 provided to the centralized platform, metrics derived from data ascertained by web crawlers associated with server 210, outputs of one or more of computer vision module 315, mapping module 320, optimization module 250, etc. For example, user 270 may indicate via the centralized platform that they desire to reduce the amount of time, complexity, intensity/effort required to perform activities and overall workflows, in which this serves as a baseline metric and time studies performed by time study module 360 are thorough analyses of not only time required to complete activities, but also the level of exertion utilized by facility personnel, amount of redundant traversing of the industrial floor by facility personnel or other applicable resources, level of engagement of operators with equipment, health status of equipment (e.g., equipment functioning/performance, software requirement, etc.), location of equipment, analytics of user 270 interacting with the virtual facility, ergonomics of facility personnel, etc. In some embodiments, time study module 360 is configured to ascertain both the time for the workflow overall and the time for the activities of the workflow and transmit both for utilization for training datasets associated with the one or more machine learning models in order for the amount of time associated with the optimized virtual activity to be obtained. In addition, time study module 360 is further configured to perform comparative quality evaluations of activities of workflows in order to provide inefficiency reduction module 370 with the necessary information in order to determine whether activities are inefficient. In some embodiments, level of exertion, lack of attentiveness, and other applicable ergonomics-derived data are able to be ascertained by the analyses performed by time study module 360.

Inefficiency reduction module 370 is designed to utilize the time studies performed by time study module 360 in order to reduce inefficiencies associated with activities of workflows in order to optimize workflows overall. For example, based on analyses of sensor data collected from sensor system module 310 and mapping of equipment functionalities to facility personnel, an output of the one or more machine learning models maintained by machine learning module 350 is generated indicating that a transporter of the facility is needlessly traversing the industrial floor; thus, classifying the activity as non-value adding based on the time study indicating a significant amount of time is being utilized to complete the activity and that the activity is inefficient and non-value adding. As a result, inefficiency reduction module 370 generates virtual paths for the facility personnel to traverse on the industrial floor in order to reduce the amount of time utilized to perform the activity. Furthermore, inefficiency reduction module 370 may account for other factors that may impact efficiency of an activity, such as but not limited to obstructions/detours within the industrial floor, etc. It should be noted that reduction of inefficiency of workflows and activities thereof as described herein may also include mitigation, preventative measures, maintenance operations, and/or the like associated with resources of the facility.

Adaptation module 380 is designed to dynamically adapt the virtual content including the optimized activity in order for augmented reality module 325 to depict the virtual facility integrated the optimized activity to improve the workflow. Dynamic adaptation of the virtual content is configured to account for contextual situations in an AR-based defined area of the virtual facility to assist user 270 in applying scheduling/availability of resources, operator level of knowledge/experience associated with resource, configuration updates/remedies of resources, etc. Adaptation module 380 is configured to utilize general adversarial networks (GANs) and/or any other applicable AR content mechanisms configured to support dynamic virtual content generation/modification. In addition, adaptation module 380 may also facilitate instructions of the operator of facility resources to modify the layout of the virtual facility by inserting the virtual replacement resources within the virtual facility in the instance of failure, age, unavailability, software upgrading, etc. of the current resource. For example, an equipment associated with a workflow may be down/inoperable and the current operator on the industrial floor may not have the user operation privileges to interact with the equipment in the virtual facility seeking to supplement the inoperable equipment, in which user 270 may utilize the centralized platform to modify/update the user operation privileges associated with the supplemental equipment in order to facilitate access of the current operator to the supplemental equipment, or ascertain the feasibility of inserting replacement equipment and its impact on efficiency of the workflow. Adaptation module 380 modifies the applicable virtual content accordingly so that is reflected within the virtual facility depicted to user 270.

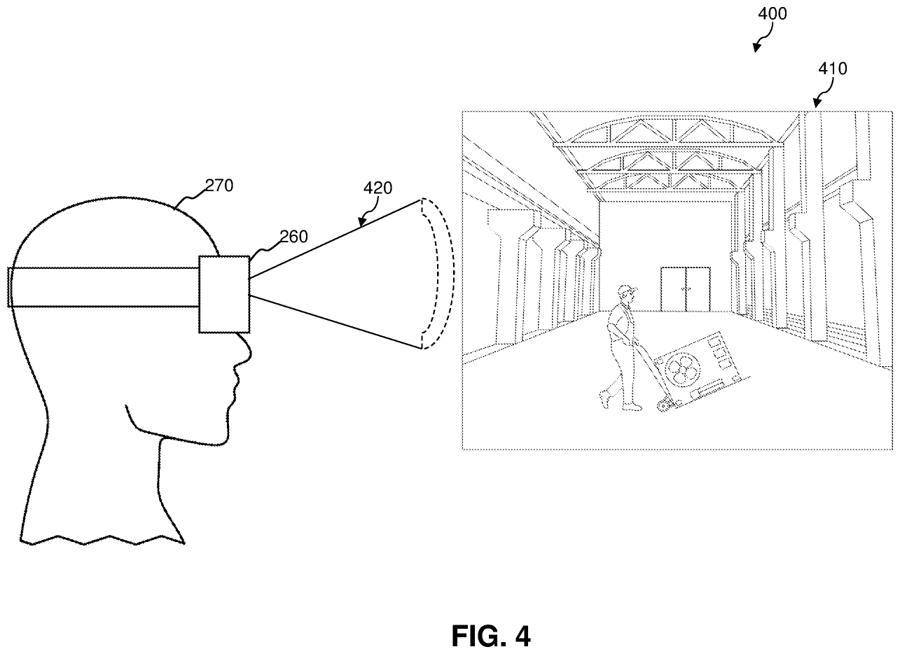

Referring now to FIG. 4, an example virtual environment 400 of an industrial floor 410 of the facility as a depiction 420 viewed through computing device 260 (i.e., a computer-mediated reality device donned by user 270), in accordance with an embodiment of the present invention. Depiction 420 illustrates the virtual facility in which visual indicators representing mappings of facility resources to workflows, activities, processes, etc. of the facility rendered by mapping module 320, virtual paths and instructions symbolizing previous routes and/or suggested routes for facility personnel within the industrial floor, user operation privileges of equipment/machinery, availability/functionality of equipment/machinery, health status of facility resources, engagement level of facility resources (e.g., operator attentiveness, etc.), etc. Virtual environment 400 is initially generated by augmented reality module 325 based on sensor data collected by sensor system module 310 and analyses performed by computer vision module 315. In some embodiments, the generation of virtual environment 400 is based on one or more workflows provided by server 210 and/or user 270 via the centralized platform. For example, user 270 may provide a workflow specifying equipment, operators, preferred timeframes for conducting, scheduling, activities, applicable data feeds associated with facility resources to be accessed, etc., in which mapping of virtual environment 400 is conducted based upon the provided workflow in addition to the aforementioned sensor data and analyses. In some embodiments, augmented reality module 325 is further configured to utilize the collected sensor data and applicable data feeds of the facility resources in order to generate digital replicas of facility resources that model equipment, machinery, etc. in order to provide simulations of facility resources within the industrial floor. In addition to the digital replicas providing simulations, they also allow predictions generated by machine learning module 350 associated with potential location placement of equipment in the facility (i.e., industrial floor design), workflows, activities, and facility-specific events (e.g., accidents, outages, issues, etc.) to be manifested and viewed by user 270 within the virtual facility. Dynamic adaptions to the virtual content generated by adaptation module 380 may be representative of elimination, mitigation, maintenance, preventative measures, etc. associated with the activities and/or workflow based upon the predictions. However, dynamic adaptions may be conditioned upon classification of the activity in which the optimization of the value-added activity is accomplished by elimination of the inefficient components of the value-added activity detected by inefficiency reduction module 370 and/or completion of the dynamically adapted virtual content of the virtual facility depicted through visual indicators that represent optimizing acts (e.g., optimized virtual traversing paths for facility personnel, virtually enacted issue mitigating acts on the industrial floor, etc.). In some embodiments, when an activity is classified as non-value adding, inefficiency reduction module 370 determines that the activity needs to be eliminated entirely; thus, optimizing one or more components of the applicable workflow.

Furthermore, dynamic adaptations to the virtual content rendered by adaptation module 380 allow critical information such as health status of machinery, equipment placement location within the industrial floor, functions/roles of facility personnel, level of efficiency (e.g., attentiveness, regulation compliance, physical overexertion), etc. to be accounted for within virtual environment 400. For example, if user 270 is attempting to determine why a specific machinery within the industrial floor is subject to frequent power-loss, then the ability for user 270 to move the digital replica of the specific machinery to a different location within the industrial floor via interaction with the virtual facility allows user 270 to ascertain that it is the current placement of the specific machinery that is causing unnecessary drawing of energy resulting in outages; however, actual movement of the specific machinery may result in an impact on the traversing of the industrial floor by facility personnel directly adverse to the efficiency of a workflows. Therefore, the digital replica prospective placement feature based on the aforementioned predictions allows user 270 to ascertain which location within the industrial floor mitigates the issue most efficiently without negatively impacting workflows. Furthermore, the predictions of machine learning module 350 made based on the previous knowledge of operators, their tasks, user operation privileges to equipment, etc. allows the optimal location to be selected in a manner that has the least amount of impact on value-adding activities that are simultaneously being optimized by optimization module 250.

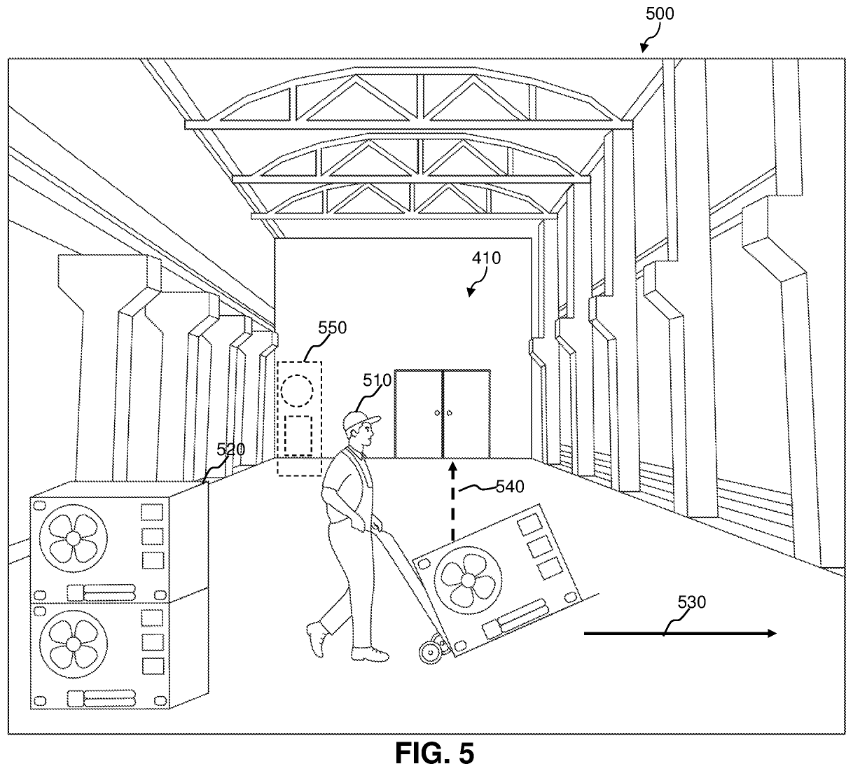

Referring now to FIG. 5, an optimized virtual environment 500 illustrating industrial floor 410 comprising a plurality of visual indicators generated by optimization module 250 as viewed from the computer-mediated reality device, according to an exemplary embodiment. Optimized virtual environment 500 comprises an industrial floor operator 510 tasked with interacting with facility equipment 520. In the provided example, interactions of operator 510 with equipment 520 includes but are not limited to programming, transporting, providing maintenance, or any other applicable interactions of operators with equipment/machinery known to those of ordinary skill in the art. Optimized virtual environment 500 further comprises a predicted traversal path 530 and an optimized traversal path 540 of industrial floor 410, in which predicted traversal path 530 is generated by augmented reality module 325 based on historical activity data of industrial floor traversing by facility personnel analyzed by machine learning module 350 and optimized traversal path 540 is generated by adaptation module 380 based on an optimization analysis of predicted traversal path 530 performed by inefficiency reduction module 370. For example, time study module 360 performed a time study on predicted traversal path 530 in which it was determined that previous traversal paths associated with predicted traversal path 530 were not only non-value added activities based on the score impacted by the amount of time to complete the activity exceeding the activity threshold (i.e., the time to complete the activity is so long that it is efficient), but also that the previous traversal paths associated with predicted traversal path 530 are inefficient and should be eliminated altogether based on analyses performed by inefficiency reduction module 370. Thus, inefficiency reduction module 370 indicating elimination of predicted traversal path 530 is necessary in order to optimize the applicable activity via adaptation module 380 generating optimized traversal path 540 for visualization within optimized virtual environment 500. Therefore, operator 510 traversing industrial floor 410 along optimized traversal path 540 optimizes one or more value-adding activities associated with the applicable workflow.

In some embodiments, optimized virtual environment 500 further comprises digital replica(s) 550 of equipment 520 generated by adaptation module 380 based on user inputs by user 270 on the centralized platform or applicable AR interface indicating manipulations to the virtual facility. For example, manipulation of digital replica 550 may not only represent a location on industrial floor 410 in which equipment 520 may potentially be placed at the discretion of user 270, but also user 270 may also perform accessing, maintenance, task identification of facility personnel associated with equipment 520 or any other applicable machinery, etc. In other embodiments, manipulations to the virtual facility on the centralized platform or applicable AR interface may facilitate functions such as simulations of system, processes, services, etc. associated with equipment 520. For example, in the instance in which equipment 520 is consumer premises equipment (CPE), the process of user 270 interacting with digital replica 550 may function as a physical representation of equipment 520 within the virtual facility and any applicable hardware/software errors associated with equipment 520 are displayed to operator 510 using the centralized platform or applicable AR interfaces to simplify tasks that optimize activities of the workflows (e.g., troubleshooting, activity elimination, etc.) that operator and/or user 270 can repair and manage components of equipment 520, such as software implementation problems, by rendering software components as their equivalent physical representations.

In addition to activities being identified by activity detection module 330, inefficiencies of activities are configured to be detected by time study module 360 and mappings performed by mapping module 320 between graphical representation with nodes representing equipment 520 and the inefficiencies are rendered. For example, a mapping between the detected inefficiencies on the API calling to the representations of the nodes is used to provide visual indications and representations of the inefficiencies and associated optimizations within optimized virtual environment 500. Furthermore, health statuses of equipment 520 and facility personnel, ergonomics-based data associated with facility personnel (e.g., physical ergonomics, cognitive ergonomics, organizational ergonomics, etc.), assignment of workflows/activities to facility resources, etc. are configured to be represented via visual representations within optimized virtual environment 500 dynamically generated by adaptation module 380. In some embodiments, the aforementioned visual representations and indicators associated with facility resources may be triggered by augmented reality module 325 determining a gaze direction of user 270 and adaption module 380 dynamically adapting the virtual content of the applicable facility resources within the detected gaze direction. Analytics associated with interactions of user 270 with the virtual facility may also be ascertained via inefficiency reduction module 370 in which the virtual facility interaction analytics (e.g., amount time user 270 spends interacting with optimized virtual environment 500, most interacted with facility resources, etc.) are made available via the centralized platform. For example, time study module 360 may examine not only activities of user 270 within the virtual facility, but also whether an activity of user 270 within the virtual facility is value adding based on factors such as, but not limited to, change in focus of user 270 while performing movements within the virtual facility that have no impact on the workflow, etc. In particular, time study module 360 may analyze behavioral data of user 270 to determine if additional movement within the virtual facility will distract user 270 from the activity, analyze the activity within the virtual facility surrounding user 270, identify ergonomics within the virtual facility, etc. As a result, inefficiency reduction module 370 identifies components such as the minimum amount of space required for an activity to be effectively accomplished and adaptation module 380 renders optimized virtual environment 500 reflecting visual indicators showing how the non-value activity may be controlled.

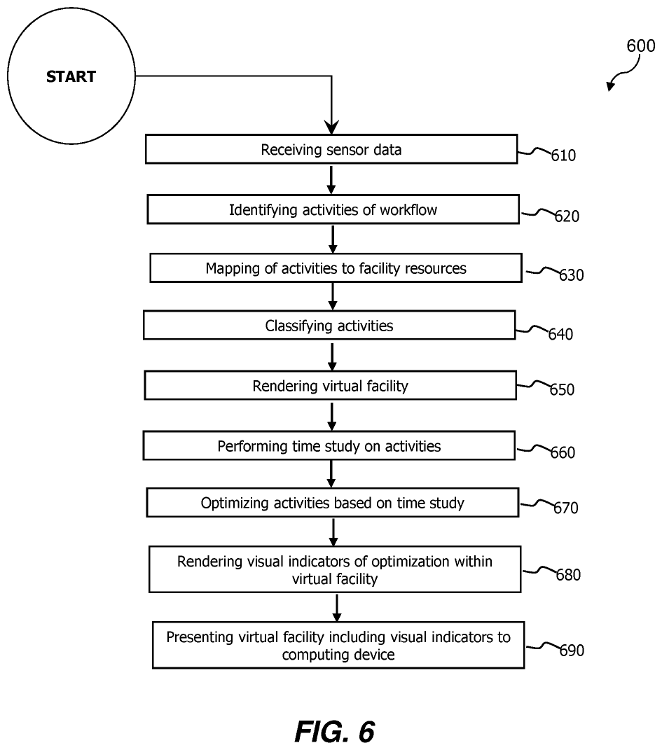

With the foregoing overview of the example architecture, it may be helpful now to consider a high-level discussion of an example process. FIG. 6 depicts a flowchart illustrating a computer-implemented process 600 for a method for optimizing activities, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, sensor system module 310 receives the sensor data from the applicable sensors associated with the facility. In some embodiments, data feeds associated with facility resources along with environmental data of the facility, location data of facility resources, historical facility data, applicable data derived from knowledge corpuses, data derived from web crawlers associated with server 210 (e.g., unit-specific information of equipment, etc.), and applicable third party sources (e.g., social media platforms, weather platforms, etc.) are collected by sensor system module 310. Furthermore, various other types of data may be acquired by one or more measurement devices (e.g., to measure static electricity in various equipment sections/surroundings, temperature, humidity, other environmental conditions/parameters, vibration, friction, liquid flow speed through pipes, etc.), one or more monitoring devices (e.g., microphones, etc.), and/or the like associated with the facility and/or facility resources.

At step 620 of process 600, optimization module 250 identifies activities of workflows via activity detection module 330. In particular, activities of workflows associated with the facility are acquired based on analyses performed on sensor data and/or data feeds of facility resources rendered by computer vision module 315. It should be noted that object detection, image analysis, and any other applicable image/video analysis techniques known to those of ordinary skill in the art. For example, based on the operator traversing the industrial floor in the direction of a particular equipment or user 270 viewing thereof, activity detection module 330 may determine that a particular activity of a particular workflow associated with the particular equipment is currently being or about to be performed. In some embodiments, server 210 may utilize supervised machine learning models maintained by machine learning module 350 to determine predictions of activities of workflows. In some embodiments, a particular workflow is received by optimization module 250 via user 270 providing the workflow on the centralized platform, in which the rending of the virtual facility by augmented reality module 325 is based on the received workflow.

At step 630 of process 600, mapping module 320 performs mapping of the identified activities to the facility resources. In some embodiments, mapping may be performed based on previous mappings associated with the facility and its workflows stored in facility module database 240; however, mapping module 320 is continuously generating mappings of workflows and activities to facility resources based on relevant outputs of computer vision module 315 and machine learning module 350 in which mapping module 320 maps workflows and activities to locations and facility resources within the industrial floor and stores the mappings in facility module database 240. For example, the collected sensor data may indicate that a particular operator is approaching specific equipment indicating a particular workflow is occurring, mapping module 320 maps the activities of the particular workflow to the applicable facility resources based on this indication. In some embodiments, mapping module 320 may generate the mappings taking into account applicable rules, regulations, compliances, etc. in order to ensure that workflows of the facility are being optimized in accordance with applicable governance.

At step 640 of process 600, classification of the activities of the workflow are classified by activity classification module 340. As previously mentioned, activities are classified as value-adding or non-value adding based on factors including but not limited to the amount of physical movements required within the industrial floor by facility personnel to perform the activity, the amount of virtual movement required by user 270 within the virtual facility to facilitate the activity (e.g., equipment is down and replacement equipment is in a different location, etc.), the availability of the facility resource, etc. For example, equipment being down within the facility would require user 270 to perform unnecessary traversing of the virtual facility in search of the supplemental equipment that would be used to render the workflow otherwise associated with the equipment that is down; thus, the unnecessary traversing of the industrial floor would be classified as a non-value adding activity by activity classification module 340.

At step 650 of process 600, augmented reality module 325 renders the virtual facility. In some embodiments, the virtual facility is rendered based on the results of the analyses performed on sensor data and other applicable facility data collected along with the accessed mappings within facility module database 240. It should be noted that embodiments of the invention contemplate three-dimensional views that are presented via virtual reality, augmented reality, and/or mixed reality techniques. The visual indicators associated with facility resources, workflows, activities, role assignments, etc. are superimposed over the virtual facility for view by user 270 via computing device 260. In some embodiments, the centralized platform provides an interactive virtual facility configured to be interacted with by user inputs of user 270 applied to user interfaces presented to computing device 260 in instances in which computing device 260 is not a computer-mediated reality device. As described previously, the computer-mediated reality device displays facility resource visual indicators and ultimately optimization-based visual indicators overlayed on the virtual facility; however although visual styles are generally described here, it should be understood that they are not so limited and any type or combination of visual styles may be used to indicate optimizations, facility resource information, digital replicas, such as for example, applying an artificial/virtual color to facility resource elements, presenting virtual facility resources and optimizations as flashing objects, providing annotations next to facility resources, enhancing the brightness of a facility resource within a view, or any other applicable manner of making a facility resource stand out to user 270.

At step 660 of process 600, time study module 360 performs a time study on the one or more activities of the applicable workflow. The time study performed on an activity not only analyzes the amount of time it takes to perform an activity, but also determines if additional movement of user 270 and/or facility personnel within the virtual facility will distract user 270 from the activity, analyzes the activity within the virtual facility surrounding user 270, and identifies ergonomics within the virtual facility.

At step 670 of process 600, inefficiency reduction module 370 optimizes the one or more activities based on the time study. In addition to seeking to reduce the amount of time an activity associated with a workflow requires, inefficiency reduction module 370 also identifies components associated with the activity, such as the minimum amount of space within the facility required for the activity to be effectively accomplished allowing adaptation module 380 to render optimized virtual environments of the virtual facility reflecting visual indicators showing how the non-value activity may be controlled.

At step 680 of process 600, adaptation module 380 renders the visual indicators representing optimizations within the virtual facility. In particular, the optimizations represented by visual indicators may function as prioritizing, minimizing, and/or predicting industrial floor workflow time reduction/overall activity elimination, mitigation, preventative measures, and/or maintenance. In some embodiments, the optimizations are a simulation associated with generated digital replicas and/or other applicable facility resources configured to interact with user 270 in order to optimize the detected inefficiency in real-time.

At step 690 of process 600, the virtual facility including the visual indicators generated by adaptation module 380 are presented to computing device 260. In particular, the visual indicators are manifested within the virtual content depicted within the virtual facility for the purpose of interaction with user 270. The visual indicators may portray text/notifications, avatars, virtual paths supporting various flashing/illuminating features, etc. designed to be presented to user 270 within the virtual facility on the computer-mediated reality device, in which the visual indicators may support contouring, opaqueness, semi-transparency, picture-in-picture (PIP) functions, or any other applicable virtual content features known to those of ordinary skill in the art.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for optimizing activities, the method comprising:
receiving, by a computing device, at least one workflow associated with a facility;
rendering, by the computing device, a virtual environment of the facility based on the workflow;
analyzing, by the computing device, a plurality of activities of a user associated with the workflow; and
optimizing, by the computing device, the workflow within the virtual environment based on the analysis.

2. The computer-implemented method of claim 1, wherein the facility is an industrial floor.

3. The computer-implemented method of claim 1, wherein analyzing the plurality of activities comprises:
conducting, by the computing device, a time study of the plurality of activities; and
classifying, by the computing device, an activity of the plurality of activities as a value added activity or non-value added activity based on the time study.

4. The computer-implemented method of claim 3, wherein optimizing the workflow comprises:
optimizing, by the computing device, the value added activity or non-value added activity within the facility based on the time study.

5. The computer-implemented method of claim 1, wherein rendering the virtual environment of the facility comprises:
receiving, by the computing device, a plurality of sensor data associated with the facility;
receiving, by the computing device, data feeds of equipment associated with the facility;
generating, by the computing device, virtual representations of the equipment; and
mapping, by the computing device, the plurality of activities to the equipment based on at least the plurality of sensor data.

6. The computer-implemented method of claim 5, wherein analyzing the plurality of activities comprises:
determining, by the computing device, user operation privileges of the equipment associated with the user; and
updating, by the computing device, permissions of the equipment associated with the facility based on the mapping.

7. The computer-implemented method of claim 1, further comprising:
aggregating, by the computing device, the plurality of activities based on the analysis; and
dynamically adapting, by the computing device, the virtual environment based on the optimization resulting in virtual mobility optimization associated with the user.

8. A computer program product for optimizing activities, the computer program product comprising or more computer readable storage media and program instructions collectively stored on the one or more computer readable storage media, the stored program instructions comprising:
program instructions to receive at least one workflow associated with a facility;
program instructions to render a virtual environment of the facility based on the workflow;
program instructions to analyze by the computing device, a plurality of activities of a user associated with the workflow; and
program instructions to optimize the workflow within the virtual environment based on the analysis.

9. The computer program product of claim 8, wherein the program instructions to analyze the plurality of activities comprise:
program instructions to conduct a time study of the plurality of activities; and
program instructions to classify an activity of the plurality of activities as a value added activity or non-value added activity based on the time study.

10. The computer program product of claim 9, wherein the program instructions to optimize the workflow comprise:
program instructions to optimize the value added activity or non-value added activity within the facility based on the time study.

11. The computer program product of claim 8, wherein the program instructions to render the virtual environment of the facility comprise:
program instruction to receive a plurality of sensor data associated with the facility;
program instructions to receive data feeds of equipment associated with the facility;
program instructions to generate virtual representations of the equipment; and
program instructions to map the plurality of activities to the equipment based on at least the plurality of sensor data.

12. The computer program product of claim 11, wherein the program instructions to analyze the plurality of activities comprise:
program instructions to determine user operation privileges of the equipment associated with the user; and
program instructions to update permissions of the equipment associated with the facility based on the mapping.

13. The computer program product of claim 8, further comprising:
program instructions to aggregate the plurality of activities based on the analysis; and
program instructions to dynamically adapt the virtual environment based on the optimization resulting in virtual mobility optimization associated with the user.

14. A computer system for optimizing activities, the computer system comprising:
one or more processors;
one or more computer-readable memories;
program instructions stored on at least one of the one or more computer-readable memories for execution by at least one of the one or more processors, the program instructions comprising:
program instructions to receive at least one workflow associated with a facility;
program instructions to render a virtual environment of the facility based on the workflow;
program instructions to analyze a plurality of activities of a user associated with the workflow; and
program instructions to optimize the workflow within the virtual environment based on the analysis.

15. The computer system of claim 14, wherein the facility is an industrial floor.

16. The computer system of claim 14, wherein the program instructions to analyze the plurality of activities comprise:
program instructions to conduct a time study of the plurality of activities; and
program instructions to classify an activity of the plurality of activities as a value added activity or non-value added activity based on the time study.

17. The computer system of claim 14, wherein the program instructions to optimize the workflow comprise:
program instructions to optimize the value added activity or non-value added activity within the facility based on the time study.

18. The computer system of claim 14, wherein the program instructions to render the virtual environment of the facility comprise:
program instruction to receive a plurality of sensor data associated with the facility;
program instructions to receive data feeds of equipment associated with the facility;
program instructions to generate virtual representations of the equipment; and
program instructions to map the plurality of activities to the equipment based on at least the plurality of sensor data.

19. The computer system of claim 18, wherein the program instructions to analyze the plurality of activities comprise:
program instructions to determine user operation privileges of the equipment associated with the user; and
program instructions to update permissions of the equipment associated with the facility based on the mapping.

20. The computer system of claim 14, further comprising:
program instructions to aggregate the plurality of activities based on the analysis; and
program instructions to dynamically adapt the virtual environment based on the optimization resulting in virtual mobility optimization associated with the user.
